(19) United States
(12) Patent Application Publication
(10) Pub. No.: US 2026/0080680 A1
(43) Pub. Date: Mar. 19, 2026

(54) VIDEO DETECTION METHOD AND ADULT SEX PRODUCT

(71) Applicant: Guangzhou Tiankang Limei Electronic Technology Co., Ltd., Guangzhou (CN)

(72) Inventors: Lei Zhong, Beijing (CN); Hao Chen, Guangzhou (CN); Yihua Zhou, Shimen County (CN); Jie Liu, Ganzhou (CN)

(21) Appl. No.: 18/890,689

(22) Filed: Sep. 19, 2024

(51) Int. Cl. G06V 20/40; A61H 19/00; G06V 10/82

(52) U.S. Cl. CPC G06V 20/41; A61H 19/00; G06V 10/82; G06V 20/46; A61H 2201/501

(57) ABSTRACT

The present disclosure provides a video detection method and an adult sex product. A target video image is inputted into a convolutional neural network (CNN) model for feature extraction to obtain a feature image of each frame. Extracted feature images are then classified. A system scores classified feature images, generates an auxiliary control signal based on a scoring result, and sends the auxiliary control signal to an external adult sex product to control its motion mode, thereby implementing synchronization or interaction between the video content and the device motion.

### TECHNICAL FIELD

The present disclosure relates to the field of online video detection, and in particular, to a video detection method and an adult sex product.

### BACKGROUND

With the rapid development of society, adult sex products have been used by the general public. Adult sex products, also known as sex toys such as vibrators, dildos and artificial vaginas, are mainly used to enhance or assist the sexual experience of adults for self-stimulation or use with partners, to help achieve sexual pleasure.

When used by singles, adult sex products are usually used with adult videos to enhance the sexual experience. Currently, during use of an adult sex product, a control signal of the adult sex product cannot be adjusted based on images in an adult video, resulting in a weak sense of interaction for singles using the adult sex product while watching the adult video, and a failure in adjusting the adult sex product based on the image content and the sexual motion of people, which affects user experience for the adult sex product.

### SUMMARY

In view of this, it is necessary to provide a video detection method and an adult sex product to solve the above problem.

The present disclosure provides a video detection method. The method includes:
acquiring a target video image;
inputting the target video image into a convolutional neural network (CNN) model, and performing, by the CNN model, feature extraction on each frame of the target video image to obtain feature images of all frames;
detecting, by the CNN model, the feature images of all the frames to obtain classified feature images; and
scoring the classified feature images to obtain scored feature images, obtaining an auxiliary control signal based on the scored feature images, and sending the auxiliary control signal to an external adult sex product to control a motion of the external adult sex product.

In at least one embodiment of the present disclosure, the step of detecting, by the CNN model, the feature images of all the frames to obtain classified feature images includes:
calculating a confidence score in each frame of the feature images of all the frames, to obtain confidence scores corresponding to all the frames; and
classifying the feature images of all the frames based on the confidence scores corresponding to all the frames to obtain the classified feature images.

In at least one embodiment of the present disclosure, the step of scoring the classified feature images to obtain scored feature images, and obtaining an auxiliary control signal based on the scored feature images includes:
comparing confidence scores corresponding to the classified feature images with a confidence threshold one by one, and determining that the classified feature images are auxiliary images if the confidence scores corresponding to the classified feature images are greater than the confidence threshold.

In at least one embodiment of the present disclosure, the step of scoring the classified feature images to obtain scored feature images, and obtaining an auxiliary control signal based on the scored feature images further includes:
selecting a maximum confidence from the confidence scores corresponding to the classified feature images to mark an original image corresponding to the maximum confidence as an augmented auxiliary image, and generating the auxiliary control signal based on the augmented auxiliary image.

In at least one embodiment of the present disclosure, the method further includes:
calculating a precision based on confidence scores corresponding to the classified feature images and confidence scores corresponding to all the frames, and outputting an auxiliary control signal if the precision is greater than a precision threshold.

In at least one embodiment of the present disclosure, the method further includes:
performing partial feature extraction on the classified feature images if the precision is less than the precision threshold, to obtain partially-extracted feature images; and
scoring the partially-extracted feature images to obtain part classification video-assisted scores.

In at least one embodiment of the present disclosure, the method further includes:
calculating a recall rate based on the part classification video-assisted scores, using the recall rate as a final score, and outputting the final score.

In at least one embodiment of the present disclosure, the step of performing partial feature extraction on the classified feature images if the precision is less than the precision threshold, to obtain partially-extracted feature images includes:
acquiring a feature image corresponding to a maximum confidence score in the classified feature images, and performing partial feature extraction to obtain a partially-extracted feature image;
acquiring a partial feature image of a previous frame and a partial feature image of a next frame of the partially-extracted feature image; and
calculating confidence scores of the partial feature image of the previous frame and the partial feature image of the next frame of the partially-extracted feature image to obtain reviewed confidence scores of the frames.

In at least one embodiment of the present disclosure, the step of calculating a recall rate based on the part classification video-assisted scores, using the recall rate as a final score, and outputting the final score includes:
calculating the recall rate based on the reviewed confidence scores of the frames and the confidence scores corresponding to all the frames, and if the recall rate is greater than a recall threshold, generating a final control signal based on the feature image corresponding to the maximum confidence score in the classified feature images, the partial feature image of the previous frame, and the partial feature image of the next frame, and sending the final control signal to an external adult sex product.

An adult sex product is provided. The adult sex product adopts the video detection method described above. The adult sex product includes:
a receiving module, configured to receive an auxiliary control signal or a final control signal; and
a motion module, configured to execute the auxiliary control signal or the final control signal to adjust a motion mode.

Implementations of the video detection method of this embodiment have at least the following beneficial effects:

In the video detection method and the adult sex product provided above, a system acquires a target video image, and then inputs the target video image into a CNN model for deep feature extraction to obtain feature image of each frame.

Extracted feature images are then classified by the CNN model to distinguish different types of scenes or motions.

After the feature images are classified, the system scores classified feature images, and generates an auxiliary control signal based on a scoring result. The auxiliary control signal is sent to an external adult sex product to control its motion mode, thereby implementing synchronization or interaction between the video content and the device motion.

The synchronization between the video content and the motion of the adult sex product enhances the interactive experience of the user, and enables the user to feel a more realistic interactive effect especially when watching an adult video.

By using a convolutional neural network to perform feature extraction on images and classify the images a control signal can be automatically generated based on the video content, making the use of the adult sex product more intelligent and personalized.

By analyzing the video content and controlling the corresponding device motion, a more immersive experience can be provided to the user, enhancing the overall satisfaction of use.

### BRIEF DESCRIPTION OF THE DRAWINGS

FIG. 1 is a flowchart of an embodiment of a video detection method of the present disclosure;

FIG. 2 is a flowchart of another embodiment of the video detection method of the present disclosure;

FIG. 3 is a flowchart of still another embodiment of the video detection method of the present disclosure; and

FIG. 4 is a structural block diagram of an adult sex product of the present disclosure.

### DESCRIPTION OF REFERENCE NUMERALS

10. Adult sex product; 20. Receiving module; 30. Motion module.

### DETAILED DESCRIPTION OF THE EMBODIMENTS

The embodiments of the present disclosure are described below with reference to the accompanying drawings in the embodiments of the present disclosure. Apparently, the described embodiments are merely some rather than all of the embodiments of the present disclosure.

It should be noted that when a component is “connected” to another component, the component may be connected to the another component directly, or there may be an intermediate component. When a component is “arranged on” another component, the component may be directly arranged on the another component or there may be an intermediate component. The terms “top”, “bottom”, “upper”, “lower” “left”, “right”, “front” “rear” and similar expressions used in this specification are used for illustrative purposes only.

Some embodiments of the present disclosure are described in detail below with reference to the accompanying drawings. If no conflict occurs, the following embodiments and features of the embodiments may be combined with each other.

An embodiment of the present disclosure provides a video detection method. The method includes the following steps.

S101. Acquire a target video image.

S102. Input the target video image into a CNN model, and the CNN model performs feature extraction on each frame of the target video image to obtain feature images of all frames.

S103. The CNN model detects the feature images of all the frames to obtain classified feature images.

S104. Score the classified feature images to obtain scored feature images, obtain an auxiliary control signal based on the scored feature images, and send the auxiliary control signal to an external adult sex product to control a motion of the external adult sex product.

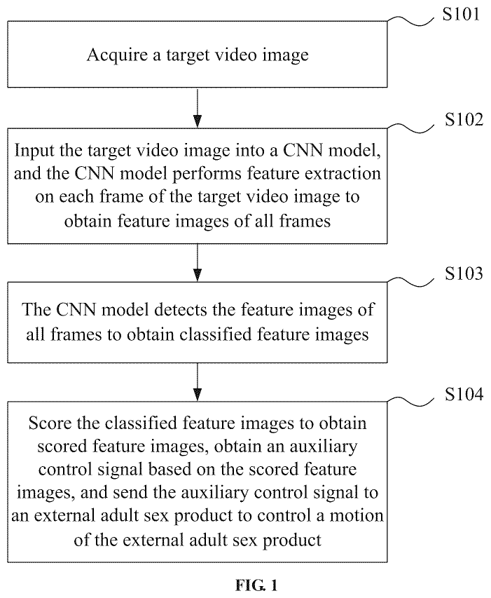

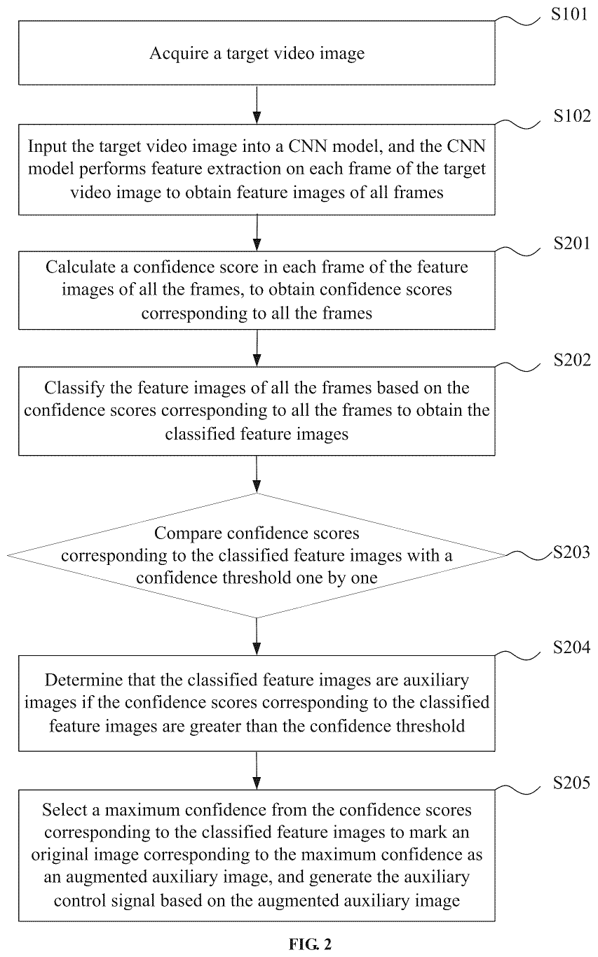

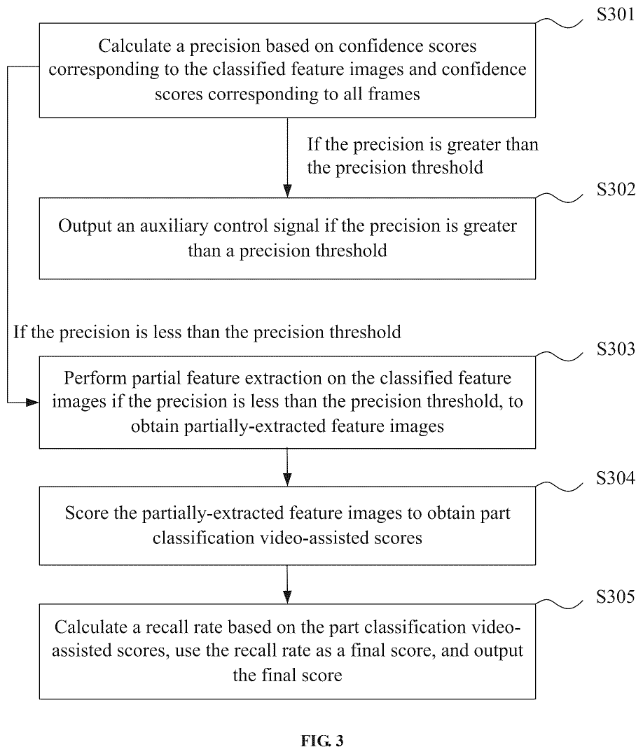

Referring to FIG. 1 to FIG. 3, in this implementation, a system acquires a target video image, and then inputs the target video image into a CNN model for deep feature extraction to obtain a feature image of each frame.

Extracted feature images are then classified by the CNN model to distinguish different types of scenes or motions.

After the feature images are classified, the system scores classified feature images, and generates an auxiliary control signal based on a scoring result. The auxiliary control signal is sent to an external adult sex product to control its motion mode, thereby implementing synchronization or interaction between the video content and the device motion.

The synchronization between the video content and the motion of the adult sex product enhances the interactive experience of the user, and enables the user to feel a more realistic interactive effect especially when watching an adult video.

By using a convolutional neural network to perform feature extraction on images and classify the images a control signal can be automatically generated based on the video content, making the use of the adult sex product more intelligent and personalized.

By analyzing the video content and controlling the corresponding device motion, a more immersive experience can be provided to the user, enhancing the overall satisfaction of use.

It should be noted that, the target video image is a video to be interacted with.

Acquiring a target video image is acquiring video image data from a data source, and the video images are usually content of adult movies.

Inputting the target video image into a CNN model is inputting the video image data into a pre-trained CNN model.

The CNN model performs feature extraction on each frame of the target video image to obtain feature images of all frames. The feature extraction is to extract key information that can represent the image content from the image.

It should be noted that, the auxiliary control signal is generated based on the time nodes and the scores of the scored feature images. For example, if the scored feature image at the tenth second has a score of 70, an auxiliary control signal is outputted, and the auxiliary control signal is executed to adjust the motion speed of the adult sex product to 70% and the motion time to the tenth second, to synchronize with the video.

In at least one embodiment of the present disclosure, the step of detecting, by the CNN model, the feature images of all the frames to obtain classified feature images includes the following substeps.

S201. Calculate a confidence score in each frame of the feature images of all the frames, to obtain confidence scores corresponding to all the frames.

S202. Classify the feature images of all the frames based on the confidence scores corresponding to all the frames to obtain the classified feature images.

In at least one embodiment of the present disclosure, the step of scoring the classified feature images to obtain scored feature images, and obtaining an auxiliary control signal based on the scored feature images includes the following substeps.

S203. Compare confidence scores corresponding to the classified feature images with a confidence threshold one by one.

S204. Determine that the classified feature images are auxiliary images if the confidence scores corresponding to the classified feature images are greater than the confidence threshold.

In at least one embodiment of the present disclosure, the step of scoring the classified feature images to obtain scored feature images, and obtaining an auxiliary control signal based on the scored feature images further includes the following substeps.

S205. Select a maximum confidence from the confidence scores corresponding to the classified feature images to mark an original image corresponding to the maximum confidence as an augmented auxiliary image, and generate the auxiliary control signal based on the augmented auxiliary image.

Referring to FIG. 1 to FIG. 3, in this implementation, the system first performs feature extraction on each image frame in the video, and then calculates a confidence score for each frame of feature image.

The system classifies the images based on the confidence score of each image frame. The classification is based on whether the images match preset category features.

The system compares confidence scores of the classified images with a preset threshold, and images whose confidence score is greater than the threshold are marked as “auxiliary images”.

The system selects an image with the highest confidence score from all the auxiliary images, and uses the confidence score as a final auxiliary control signal. The signal is used to control a motion of the external adult sex product.

By finely calculating and classifying the confidence score of each image frame, the system can generate a more precise control signal, so that the motion of the adult sex product is more in line with the interactive effect expected by the user.

The system can generate control signals in real time based on changes in the video content, so that the motion mode of the adult sex product can be dynamically adjusted, enhancing the synchronization and interaction with the video content.

By selecting the most representative image (with the highest confidence score), the system ensures that the generated control signal can guide the device action most effectively, enhancing the overall user experience.

The auxiliary control signal includes the time when the image appears, the strength of the motion mode, and the duration of the motion process.

The confidence threshold is a manually set threshold.

The CNN model performs feature extraction on each frame of the target video image to extract specific objects and scenes.

The CNN model uses two prediction heads during training, one using one-to-many assignment and the other using one-to-one assignment.

The CNN model uses one-to-many assigned rich supervision signals during training, and uses one-to-one assigned prediction results during inference, thereby achieving efficient NMS-free inference to improve the detection precision.

In at least one embodiment of the present disclosure, the method further includes the following substeps.

S301. Calculate a precision based on confidence scores corresponding to the classified feature images and confidence scores corresponding to all the frames.

S302. Output an auxiliary control signal if the precision is greater than a precision threshold.

In at least one embodiment of the present disclosure, the method further includes the following substeps.

S303. Perform partial feature extraction on the classified feature images if the precision is less than the precision threshold, to obtain partially-extracted feature images.

S304. Score the partially-extracted feature images to obtain part classification video-assisted scores.

In at least one embodiment of the present disclosure, the method further includes the following substeps.

S305. Calculate a recall rate based on the part classification video-assisted scores, use the recall rate as a final score, and output the final score.

Referring to FIG. 1 to FIG. 3, in this implementation, the system first calculates the precision based on the confidence scores of the classified feature images and all frames. If the precision is greater than the precision threshold, it indicates that the classification result is sufficiently reliable, and the system directly outputs an auxiliary control signal.

If the precision is less than the preset threshold, the system does not output the control signal immediately, but performs deeper analysis, that is, partial feature extraction, on the classified feature image. The system generates part classification video-assisted scores by scoring specific parts.

The system further calculates the recall rate based on the part classification video-assisted scores. As a comprehensive evaluation indicator, the recall rate is used as the final score. The system outputs the final control signal only when the final score is up to standard.

It should be noted that the precision threshold is a manually set threshold.

The partial feature extraction is feature extraction on exposed parts of a human body in the classified feature images.

By introducing calculation steps for the precision and the recall rate, the system can assess the reliability of the classification result more precisely, which ensures that the control signal is generated only when the classification is sufficiently precise, to avoid misoperation.

When the precision of the initial classification is not up to standard, the system performs further analysis through the partial feature extraction and detailed scores, which enables the system to maintain high recognition precision when dealing with complex or fuzzy images.

By generating a control signal with higher precision, the system can better synchronize with the video content to provide a richer and more precise interactive experience. Such precise control and feedback greatly enhance the overall satisfaction of use.

The CNN model calculates the quotient of the confidence scores corresponding to the classified feature images and the confidence scores corresponding to all the frames to obtain the precision based on the following formula:

$$Precision = ( True Positives ) / ( True Positives + False Positives ) ,$$

where Precision is the precision; and True Positives is the confidence score corresponding to each frame of the classified feature images.

True Positives+False Positives is the confidence scores corresponding to all the frames.

In at least one embodiment of the present disclosure, the step of performing partial feature extraction on the classified feature images if the precision is less than the precision threshold, to obtain partially-extracted feature images includes:
acquiring a feature image corresponding to a maximum confidence score in the classified feature images, and performing partial feature extraction to obtain a partially-extracted feature image;
acquiring a partial feature image of a previous frame and a partial feature image of a next frame of the partially-extracted feature image; and
calculating confidence scores of the partial feature image of the previous frame and the partial feature image of the next frame of the partially-extracted feature image to obtain reviewed confidence scores of the frames.

In at least one embodiment of the present disclosure, the step of calculating a recall rate based on the part classification video-assisted scores, using the recall rate as a final score, and outputting the final score includes:
calculating the recall rate based on the reviewed confidence scores of the frames and the confidence scores corresponding to all the frames, and if the recall rate is greater than a recall threshold, generating a final control signal based on the feature image corresponding to the maximum confidence score in the classified feature images, the partial feature image of the previous frame, and the partial feature image of the next frame, and sending the final control signal to an external adult sex product.

Referring to FIG. 1 to FIG. 3, in this implementation, the system selects the image with the highest confidence score from the classified feature images, and then performs feature extraction on key parts of the image, to obtain a partially-extracted feature image.

The partial feature images of the previous frame and the next frame adjacent to the current frame are acquired. Then, the system calculates confidence scores of partial features of the three frames and reviews these scores.

The system calculates the recall rate by comparing the reviewed confidence scores with the confidence scores of all frames. The recall rate is used to verify the comprehensiveness and reliability of the classification result.

If the recall rate is greater than a set threshold, the system generates a final control signal and sends the final control signal to the external adult sex product. The control signal is generated based on the image with the highest confidence score and feature images of adjacent frames of the image.

By performing partial feature extraction on the image with the highest confidence score and reviewing the scores in combination with the features of the adjacent frames, the system can capture key features more precisely and reduce the possibility of misjudgment.

By analyzing the feature images of the adjacent frames, the system can capture dynamic changes and improve the continuity of the overall analysis, helping generate a more precise final control signal.

Since the final control signal is generated based on the multi-frame review and precise calculation of the recall rate, the possibility of device misoperation due to misjudgment is greatly reduced, and the safety and reliability of use of the device are improved.

The CNN model calculates the recall rate based on the reviewed confidence scores of the frames and the corresponding confidence scores of all frames based on the following formula:

$$Recall = ( True Positives ) / ( True Positives + False Negatives ) ,$$

where Recall is the recall rate; True Positives is the reviewed confidence scores of the frames; and True Positives+False Negatives is the confidence scores corresponding to all the frames.

An adult sex product 10 is provided. The adult sex product adopts the video detection method described above. The adult sex product includes a receiving module 20 and a motion module 30.

The receiving module 20 is configured to receive an auxiliary control signal or a final control signal.

The motion module 30 is configured to execute the auxiliary control signal or the final control signal to adjust a motion mode.

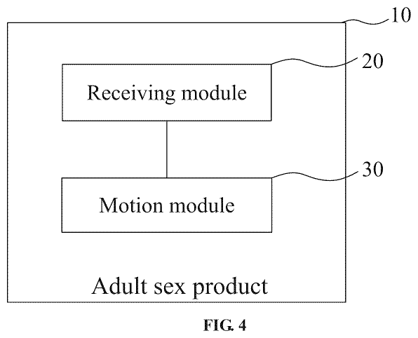

Referring to FIG. 4, in this implementation, when a user watches a video, the video detection method is started and a corresponding auxiliary control signal or final control signal is generated. The signal is then received by the receiving module of the adult sex product 10.

The receiving module 20 sends the received control signal to the motion module 30. The motion module 30 makes corresponding motion adjustments based on the signal content (for example, intensity, frequency, and time).

The motion module 30 executes instructions in the signal by adjusting the motion mode. For example, if the signal indicates that the device needs to increase a vibration frequency, the motion module 30 adjusts its motion to meet the requirement.

During the use of the adult sex product 10 by the user, the motion module 30 of the device is synchronized or associated with the video content, providing experience of interacting with the video content and enhancing the immersion and satisfaction of the user.

By synchronizing the video content with the motion mode of the adult sex product, the device can provide a more realistic interactive experience for the user. The user can not only watch the video, but also feel the context in the video through the motion of the device, which enhances the pleasure of use.

The cooperation between the receiving module 20 and the motion module 30 enables the device to intelligently adjust its motion according to a signal generated by the video detection method.

The receiving module 20 receives the signal in a time and the motion module 30 executes the signal quickly, so that the device can quickly respond to changes in the video content and providing instant feedback. Such highly responsive and precise control greatly enhances the user experience.

The above descriptions are merely implementations of the present disclosure. It should be noted herein that a person of ordinary skill in the art can make improvements without departing from the concept of the present disclosure, but such improvements shall fall within the protection scope of the present disclosure.

What is claimed is:

1. A video detection method, comprising:
acquiring a target video image;
inputting the target video image into a convolutional neural network (CNN) model, and performing, by the CNN model, feature extraction on each frame of the target video image to obtain feature images of all frames;
detecting, by the CNN model, the feature images of all the frames to obtain classified feature images; and
scoring the classified feature images to obtain scored feature images, obtaining an auxiliary control signal based on the scored feature images, and sending the auxiliary control signal to an external adult sex product to control a motion of the external adult sex product.

2. The video detection method according to claim 1, wherein the step of detecting, by the CNN model, the feature images of all the frames to obtain classified feature images comprises:
calculating a confidence score in each frame of the feature images of all the frames, to obtain confidence scores corresponding to all the frames; and
classifying the feature images of all the frames based on the confidence scores corresponding to all the frames to obtain the classified feature images.

3. The video detection method according to claim 1, wherein the step of scoring the classified feature images to obtain scored feature images, and obtaining an auxiliary control signal based on the scored feature images comprises:
comparing confidence scores corresponding to the classified feature images with a confidence threshold one by one, and determining that the classified feature images are auxiliary images if the confidence scores corresponding to the classified feature images are greater than the confidence threshold.

4. The video detection method according to claim 3, wherein the step of scoring the classified feature images to obtain scored feature images, and obtaining an auxiliary control signal based on the scored feature images further comprises:
selecting a maximum confidence from the confidence scores corresponding to the classified feature images to mark an original image corresponding to the maximum confidence as an augmented auxiliary image, and generating the auxiliary control signal based on the augmented auxiliary image.

5. The video detection method according to claim 1, further comprising:
calculating a precision based on confidence scores corresponding to the classified feature images and confidence scores corresponding to all the frames, and outputting an auxiliary control signal if the precision is greater than a precision threshold.

6. The video detection method according to claim 5, further comprising:
performing partial feature extraction on the classified feature images if the precision is less than the precision threshold, to obtain partially-extracted feature images; and
scoring the partially-extracted feature images to obtain part classification video-assisted scores.

7. The video detection method according to claim 6, further comprising:
calculating a recall rate based on the part classification video-assisted scores, using the recall rate as a final score, and outputting the final score.

8. The video detection method according to claim 6, wherein the step of performing partial feature extraction on the classified feature images if the precision is less than the precision threshold, to obtain partially-extracted feature images comprises:
acquiring a feature image corresponding to a maximum confidence score in the classified feature images, and performing partial feature extraction to obtain a partially-extracted feature image;
acquiring a partial feature image of a previous frame and a partial feature image of a next frame of the partially-extracted feature image; and
calculating confidence scores of the partial feature image of the previous frame and the partial feature image of the next frame of the partially-extracted feature image to obtain reviewed confidence scores of the frames.

9. The video detection method according to claim 8, wherein the step of calculating a recall rate based on the part classification video-assisted scores, using the recall rate as a final score, and outputting the final score comprises:
calculating the recall rate based on the reviewed confidence scores of the frames and the confidence scores corresponding to all the frames, and if the recall rate is greater than a recall threshold, generating a final control signal based on the feature image corresponding to the maximum confidence score in the classified feature images, the partial feature image of the previous frame, and the partial feature image of the next frame, and sending the final control signal to an external adult sex product.

10. An adult sex product, adopting the video detection method according to claim 1, and comprising:
a receiving module, configured to receive an auxiliary control signal or a final control signal; and
a motion module, configured to execute the auxiliary control signal or the final control signal to adjust a motion mode.

11. The adult sex product according to claim 10, wherein the step of detecting, by the CNN model, the feature images of all the frames to obtain classified feature images comprises:
calculating a confidence score in each frame of the feature images of all the frames, to obtain confidence scores corresponding to all the frames; and
classifying the feature images of all the frames based on the confidence scores corresponding to all the frames to obtain the classified feature images.

12. The adult sex product according to claim 10, wherein the step of detecting, by the CNN model, the feature images of all the frames to obtain classified feature images comprises:
calculating a confidence score in each frame of the feature images of all the frames, to obtain confidence scores corresponding to all the frames; and
classifying the feature images of all the frames based on the confidence scores corresponding to all the frames to obtain the classified feature images.

13. The video detection method according to claim 1, wherein the step of scoring the classified feature images to obtain scored feature images, and obtaining an auxiliary control signal based on the scored feature images comprises:
comparing confidence scores corresponding to the classified feature images with a confidence threshold one by one, and determining that the classified feature images are auxiliary images if the confidence scores corresponding to the classified feature images are greater than the confidence threshold.

14. The video detection method according to claim 3, wherein the step of scoring the classified feature images to obtain scored feature images, and obtaining an auxiliary control signal based on the scored feature images further comprises:
selecting a maximum confidence from the confidence scores corresponding to the classified feature images to mark an original image corresponding to the maximum confidence as an augmented auxiliary image, and generating the auxiliary control signal based on the augmented auxiliary image.

15. The adult sex product according to claim 10, wherein the video detection method further comprises:
calculating a precision based on confidence scores corresponding to the classified feature images and confidence scores corresponding to all the frames, and outputting an auxiliary control signal if the precision is greater than a precision threshold.

16. The video detection method according to claim 5, wherein the video detection method further comprises:
performing partial feature extraction on the classified feature images if the precision is less than the precision threshold, to obtain partially-extracted feature images; and
scoring the partially-extracted feature images to obtain part classification video-assisted scores.

17. The adult sex product according to claim 10, wherein the video detection method further comprises:
calculating a recall rate based on the part classification video-assisted scores, using the recall rate as a final score, and outputting the final score.

18. The adult sex product according to claim 10, wherein the step of performing partial feature extraction on the classified feature images if the precision is less than the precision threshold, to obtain partially-extracted feature images comprises:
acquiring a feature image corresponding to a maximum confidence score in the classified feature images, and performing partial feature extraction to obtain a partially-extracted feature image;
acquiring a partial feature image of a previous frame and a partial feature image of a next frame of the partially-extracted feature image; and
calculating confidence scores of the partial feature image of the previous frame and the partial feature image of the next frame of the partially-extracted feature image to obtain reviewed confidence scores of the frames.

19. The adult sex product according to claim 10, wherein the step of calculating a recall rate based on the part classification video-assisted scores, using the recall rate as a final score, and outputting the final score comprises:
calculating the recall rate based on the reviewed confidence scores of the frames and the confidence scores corresponding to all the frames, and if the recall rate is greater than a recall threshold, generating a final control signal based on the feature image corresponding to the maximum confidence score in the classified feature images, the partial feature image of the previous frame, and the partial feature image of the next frame, and sending the final control signal to an external adult sex product.
